(19) United States
(12) Patent Application Publication
(10) Pub. No.: US 2008/0101170 A1
(43) Pub. Date: May 1, 2008

(54) Wobble signal reading method and optical disk appratus

(75) Inventor: Shinichiro Arakawa, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/978,632

(22) Filed: Oct. 30, 2007

(30) Foreign Application Priority Data
Oct. 31, 2006 (JP) 2006-296636

(51) Int. Cl. G11B 7/00

(52) U.S. Cl. 369/44.13

(57) ABSTRACT

According to one embodiment, an optical disk apparatus detects that a combination of appearance patterns of a phase inversion part included in a wobble periodical pattern coincides with a pattern for determination prepared in advance, determines whether or not PLL synchronization is enabled so as to classify the degrees into a plurality of states, and effects PLL synchronization through a predetermined procedure according to the state.

### CROSS-REFERENCE TO RELATED APPLICATIONS

This application is based upon and claims the benefit of priority from Japanese Patent Application No. 2006-296636, filed Oct. 31, 2006, the entire contents of which are incorporated herein by reference.

### BACKGROUND

1. Field

One embodiment of the invention relates to a method of reading a wobble signal recorded on an optical disk which is a recording medium and an optical disk apparatus to which the reading method is applied.

2. Description of the Related Art

It has been a long time since an apparatus for handling an optical disk from which information recorded thereon can be reproduced by means of laser light or on which information can be recorded by means of laser light, i.e., an optical disk apparatus was first put to practical use. As the recording media (optical disks), optical disks conforming to the digital versatile disk (DVD) standard are now widespread.

Of optical disks of the DVD standard, in optical disks other than the ROM type play-back-only optical disks, for example, write once read many optical disks to which information can be written only once or rewritable optical disks in which information can be rewritten repetitively, recording tracks (guide grooves or flat parts which are the antipoles of grooves) are formed on the information recording surface (of a disk).

Although a physical address is recorded in advance on the recording track, it has been needed to reduce the time required to detect and read (reproduce) a leading head (or a specific position) of the recorded physical address by forming the recording track using the wobble modulation system in which the recording track is wobbled (meandered) at fixed periods.

When information recorded as the physical address is completely read and the recorded contents of the information and interpreted, the present physical address is naturally known. However, by characterizing (inverting a phase at a specific section), for example, a phase of the wobble of the recording track, the leading head (or specific) position of the physical address can be detected in a shorter time.

For example, Japanese Patent Application Publication (KOKAI) No. 2005-166118 ([0009], FIG. 5), it is disclosed that a wobble cycle counter is frequency-divided in units of WDUs or WAPs so as to achieve synchronization.

Further, in the Japanese Patent Application Publication (KOKAI) No. 2005-190561 ([0015], FIG. 4), it is disclosed that a synchronization position is detected by a comparison between a detection result of a phase change point and a synchronization pattern.

Furthermore, in the Japanese Patent Application Publication (KOKAI) No. 2005-166112 (FIG. 1), it is disclosed that regulation is effected by a coincidence of signs in an AND circuit for determining a timing at which a synchronization arrival detection result obtained from an edge level and a prescribed synchronization pattern coincide with each other in sign.

However, it is difficult to reduce the time required to be able to detect wobble synchronization (completion of wobble PLL pull-in) below a certain fixed time due to the influence of a defect (a lack of data or damage), or noise, or the like arising in the signal transfer system, even by use of any of the arbitrary methods described in the above-mentioned documents or combination of the methods.

Moreover, neither a method of reducing factors causing wobble synchronization phase shift, in which erroneous pulling into a different phase occurs at the time of wobble a PLL pull-in operation, nor a contrivance for improving the reading (reproducing) accuracy of the physical address has been found by use of any of the arbitrary methods described in the above-mentioned documents or combination of the methods.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary a diagram showing an example of an optical disk apparatus according to an embodiment of the invention;

FIG. 2 is an exemplary a diagram showing examples of wobble processing circuit elements of the optical disk apparatus shown in FIG. 1, according to the embodiment of the invention;

FIG. 3 is an exemplary a diagram showing examples of a wobble (WD) signal applied to a disk conforming to a high definition (HD) DVD standard and a modulation rule of a case where information is embedded by using phase modulation, according to the embodiment of the invention;

FIG. 4 is an exemplary a diagram showing examples of a wobble format applied to a disk conforming to an HD DVD standard, according to the embodiment of the invention;

FIG. 5 is an exemplary a flowchart showing an example of a procedure for detecting a synchronization code using wobble processing circuit elements shown in FIG. 2, according to the embodiment of the invention;

FIG. 6 is an exemplary a diagram showing an example of transition of the state in the procedure for detecting the synchronization code shown in FIG. 5, according to the embodiment of the invention;

FIG. 7 is an exemplary a diagram showing an example of a synchronization pattern of a synchronization field used in the procedure for detecting the synchronization code shown in FIG. 5, according to the embodiment of the invention;

FIG. 8 is an exemplary a diagram showing examples of correcting a synchronization phase by using the synchronization pattern of the synchronization field shown in FIG. 7, according to the embodiment of the invention; and

FIG. 9 is a diagram showing examples of correcting a synchronization phase by using the synchronization pattern of the synchronization field shown in FIG. 7, according to the embodiment of the invention.

### DETAILED DESCRIPTION

Various embodiments according to the invention will be described hereinafter with reference to the accompanying drawings. In general, according to one embodiment of the invention, an optical disk apparatus detects that a combination of appearance patterns of a phase inversion part included in a wobble periodical pattern coincides with a pattern for determination prepared in advance, determines whether or not PLL synchronization is enabled so as to classify the degrees into a plurality of states, and effects PLL synchronization through a predetermined procedure according to the state.

According to an embodiment of this invention relates to a method of detecting a synchronization pattern and wobble synchronization appearing on a fixed cycle in a wobbled pre-groove on an optical disk which is a recording medium, and an optical disk apparatus to which a detecting method thereof is applied.

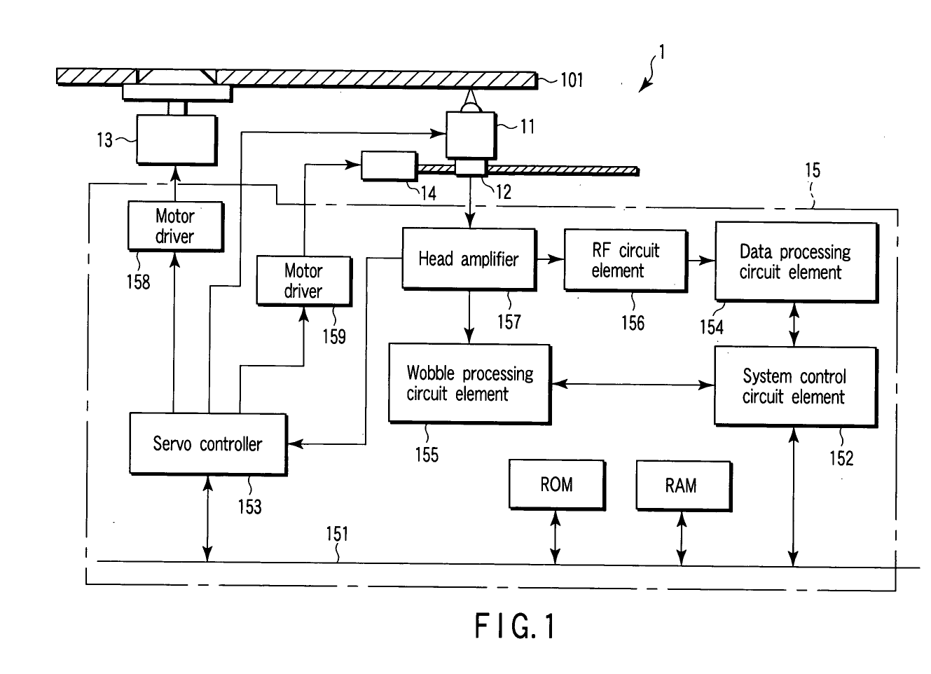

FIG. 1 shows an example of an optical disk apparatus to which an embodiment of the present invention can be applied.

An optical disk apparatus 1 shown in FIG. 1 comprises an optical head unit 11 for irradiating a recording surface of an optical disk 101 with laser light having a predetermined wavelength, a carriage 12 for holding the optical head unit 11 so as to be arbitrarily movable within a predetermined range in a radial direction along the recording surface of the optical disk, a signal processing block 15 for obtaining a predetermined signal by processing laser light reflected from the recording surface of the optical disk and obtained from the optical head unit 11, and the like. Incidentally, although not described in detail, the optical head unit 11 includes a semiconductor laser element for outputting laser light, an objective lens for converging laser light on the recording surface of the optical disk and capturing reflection laser light reflected by the optical disk, an optical detection element (photo diode-IC (PDIC)) for obtaining a predetermined signal from the reflection laser light captured by the objective lens, several optical elements for guiding laser light between the above-mentioned elements, and the like.

The signal processing block 15 obtains information recorded on a recording track from a signal photo-electrically converted by the PDIC, and processes a signal used for adjustment (focus control) of a distance between the objective lens and the recording surface of the optical disk and adjustment (track control) and the like of misalignment between laser light converged on the recording track by the objective lens and the recording track.

The signal processing block 15 includes a bus line 151, system control circuit element (main control unit) 152 connected to the bus line 151, servo controller 153, and the like. Incidentally, at least a data processing circuit element 154 and a wobble processing circuit element 155 are connected to the system control circuit element 152. Further, an RF circuit element 156 is connected to the data processing circuit element 154, and a voltage-converted photoelectric conversion output from the PDIC of the optical head unit 11 is input to the RF circuit element 156 through a head amplifier 157. Incidentally, needless to say, the head amplifier 157 may be provided so as to be integral with the PDIC.

In the signal processing block 15 described above, an RF signal (reproduced signal) is obtained from the (voltage-converted) output of the PDIC by the RF circuit element 156.

In the data processing circuit element 154, data (control information and recorded data) recorded on the optical disk is extracted from the RF signal obtained by the RF circuit element 156. Further, in the data processing circuit element 154, writing data/a control signal for writing data to a writable optical disk, e.g., a laser modulation signal and the like are produced.

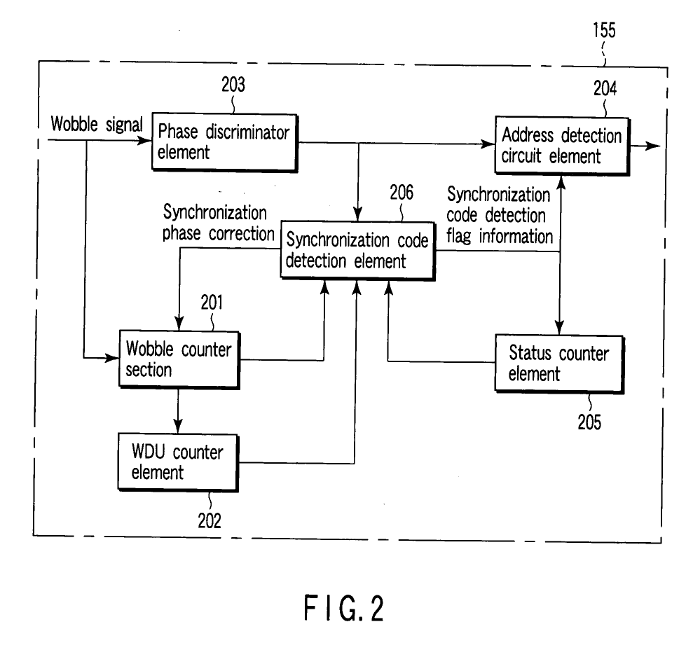

The wobble processing circuit element 155 is used to detect a specific position of a track (pre-groove) formed on the recording surface of the optical disk 101, or a recording mark string, and obtain a synchronization signal. The wobble processing circuit element 155 includes, for example, a wobble (WD) counter section 201, a wobble unit (WDU) counter element 202, a phase discriminator element 203, an address detection circuit element 204, a status counter element 205, a synchronization code detection element 206, and the like as shown in FIG. 2 in detail. Incidentally, each element may be prepared as firmware of the main control unit or may be realized by using a circuit or a small scale IC corresponding to each specific element.

In the system control circuit element 152, for example, a controlled variable for controlling a speed of a disk motor 13 for rotating the optical disk or a feed rate of a carriage motor 14 for moving the carriage 12, i.e., the optical head unit 11 along the recording surface of the optical disk is set on the basis of control information obtained by the data processing circuit element 154. Needless to say, the rotational speed of the disk motor 13 and the feed rate of the carriage motor 14 are, in fact, directly managed through motor drivers 158 and 159 connected to the servo controller 153.

Incidentally, the position of the objective lens (or an actuator for holding the objective lens) of the optical head unit 11 is controlled in such a manner that the position is within a fixed tolerance with respect to the recording track of the optical disk when a magnetic drive element (coil/magnetic body) (not shown) is moved or displaced or deformed on the basis of a control variable set in the servo controller 153. Further, when the control variable of the objective lens (actuator) is to be set, it is needless to say that when a signal component supplied directly from the head amplifier 157 to the servo controller 153 is utilized, a follow-up speed higher than a fixed speed is secured.

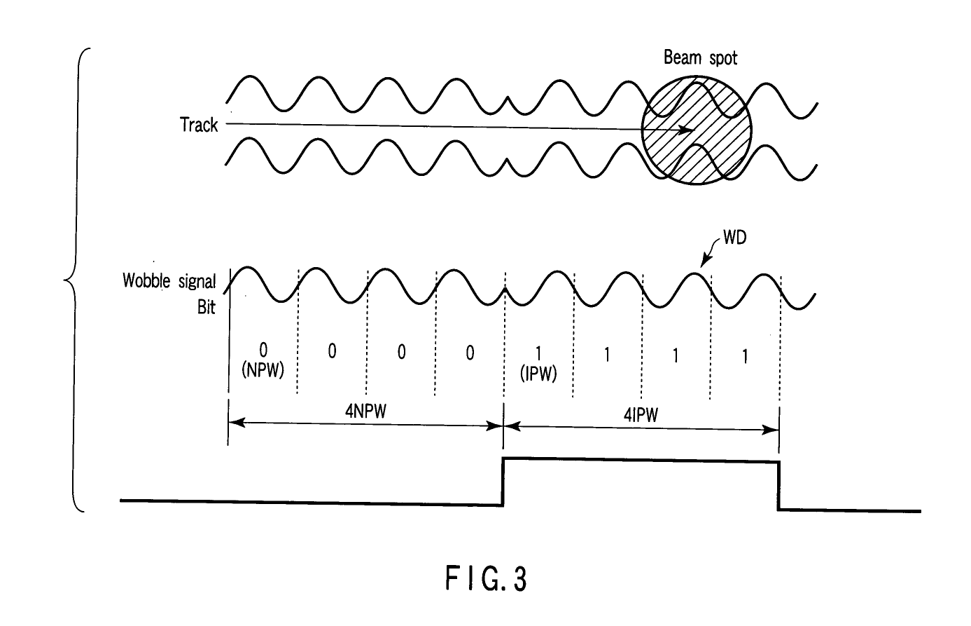

FIG. 3 shows a wobble (WD) signal applied to a disk conforming to the high definition (HD) DVD standard in which the recording density is further enhanced from the digital versatile disk (DVD) standard of the recording medium, i.e., the optical disk and, particularly, an example of a modulation rule of a case where information is embedded by using phase modulation.

The wobble (WD) signal is substantially prescribed as a sinusoidal wave in which a normal phase wave (NPW) and an inverted phase wave (IPW) are set. Incidentally, “0” is set in the NPW (normal phase wave) as bit (modulation) information, and “1” is set in the IPW (inverted phase wave).

Further, as is evident from FIG. 3, in a state where the wobble signal is updated while a position of a beam spot of laser light with which the optical disk is irradiated is fixed, i.e., in a case where a direction in which the wobble passing a position of a beam spot of the laser light is moved by the rotation of the disk is assumed to be the direction indicated by the arrow, i.e., the clockwise direction, 84 wobble (WD) signals each of which is a iT wobble signal including one maximum value and one minimum value of the signal amplitude constitute one unit (WDU). T indicates one wavelength and is also called a wobble number. Incidentally, by combining the wobble numbers of the NPW and IPW, a synchronization pattern and address information or the like can be expressed (can be embedded).

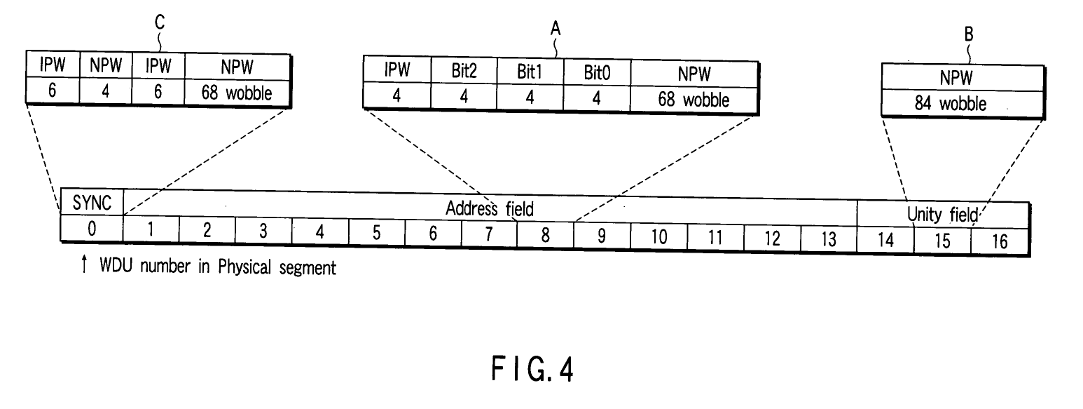

FIG. 4 shows an example of a wobble format.

In an optical disk of the HD DVD standard, in any of the standards of −R (writable only once)/−RW (rewritable)/−RAM (rewritable), information (bit) of “1” or “0” is allocated to the wobble phase in units of four wobbles (4T). Further, the information (bit), i.e., the phase-change part is intermittently arranged in the entire recording region in the disk.

Each unit (WDU) is prescribed as one of a WDU for an address field constituted of data for an address corresponding to three bits shown as an enlargement part A and one IPW,

a WDU for a unity field in which a phase-change part shown as an enlargement part B is totally absent (not prescribed), and

a WDU for a sync field to which 6T (IPW) −4T (NPW) −6T (IPW) shown as an enlargement part C are added at a leading head thereof.

Incidentally, in total 17 WDUs constitute an address unit “WAP”. The WAP is a format in which bits of a plurality of units are collected so as to express one physical address. Incidentally, a sync field is always allocated to a leading head of a WAP. That is, 17 WDUs having a sync field at their leading head out of a string of an arbitrary number of WDUs are managed as a WAP.

In other words, the WDU of the sync field is used to express a wap leading head synchronization code, each WDU used in the address field expresses a synchronization position by inversion (IPW) of leading four wobbles, and a wobble phase of subsequent 4 wobbles×3 sets expresses data of 3 bits.

When such HD DVD wobble data is to be demodulated, it is necessary to correctly detect the wobble position of the phase inversion part (IPW) without an error of even one wobble.

On the other hand, it is required that even when a wobble in the phase-change point is absent because of a defect on the disk, a deterioration in the S/N ratio (signal-to-noise ratio) of the wobble signal adversely caused by the deteriorated state of the signal transfer system or the like, such an adverse state be corrected, thereby restoring the address (enabling the physical address to be acquired).

However, in the latter requirement, if correction is excessively made, the accuracy of wobble detection positional is dropped.

Accordingly, it is naturally required that the wobble detection positional accuracy (the accuracy of wobble detection positional) and the demodulation performance be compatible with each other.

A method of detecting a wobble using a wobble processing circuit of the signal processing block will be described below with reference to FIG. 2.

Code information is extracted from a wobble signal detected from the disk through the phase discriminator circuit element 203, and the information is input to the address detection circuit element 204 and the synchronization code detection circuit element 206. Synchronization code detection flag information output from the synchronization code detection circuit element 206 is input to the status counter element 205, and the detection state of the synchronization code is managed. Incidentally, the synchronization code detection flag information is also utilized in the address detection circuit element 204.

The detection condition in the synchronization code detection circuit element 206 is switched in accordance with the synchronization status output from the status counter element 205.

On the other hand, the wobble signal (WD) is input to the wobble counter section 201, and the wobble wave number is counted therein. In the wobble counter section 201, the count value is cleared at the count of 84 (0 to 83) corresponding to one WDU and, at the same time (each time the counter section 201 is cleared), the wobble unit (WDU) counter (WDU counter) element 202 is incremented by one. In the WDU counter element 202, the count value is cleared at the count of 17 (0 to 17) corresponding to one WAP and, at the same time (each time the counter element 202 is cleared), the clearing timing information is input to the synchronization code detection circuit element 206. As will be described later, the synchronization code detection circuit element 206 can also output a synchronization code position correction signal, which is valuable for correction of the counter value in the WDU counter element 202.

### EXAMPLE 1

### In which Synchronization Code Detection Status is Managed

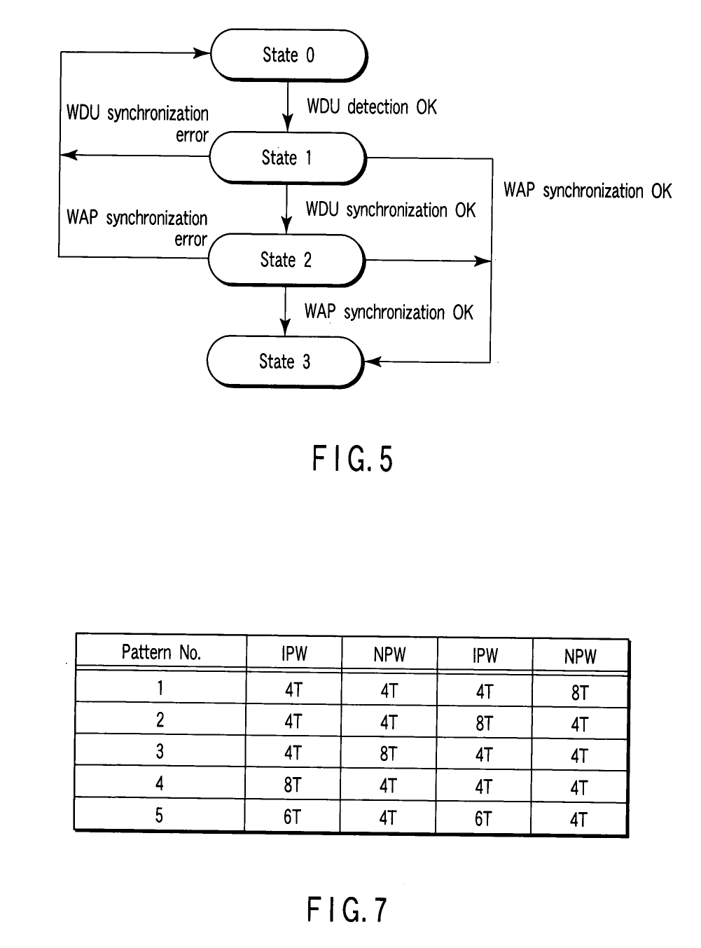

FIG. 5 shows a state transition table used when a synchronization code is detected.

As shown in FIG. 5, a status transition is classified into four states according to the synchronization state. The state 0 indicates a state where synchronization is utterly non-attained. The state 1 indicates a state where one WDU is detected. The state 2 indicates a state where successive WDUs can be detected and WDU synchronization is achieved. The state 3 indicates a state where a WDU in the top of a WAP is detected and WAP synchronization is completely achieved.

The conditions of each state transition are shown below.

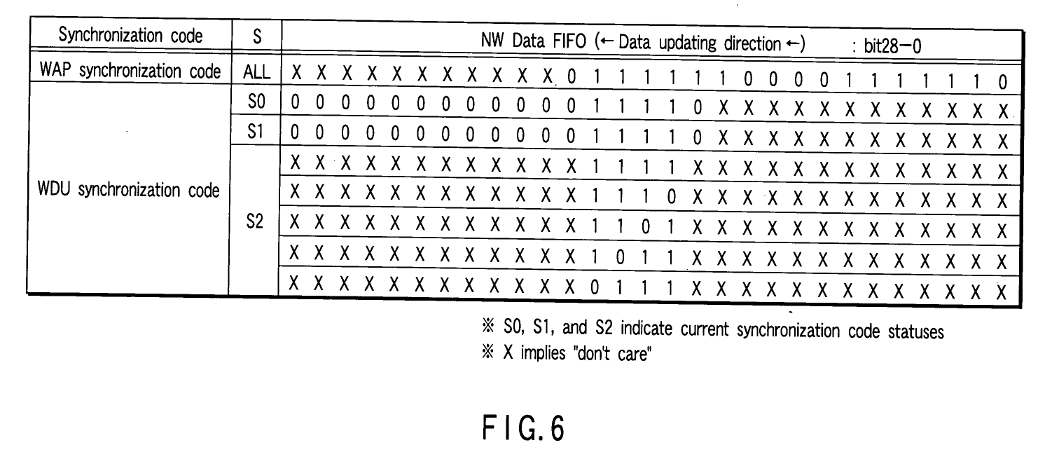

In the state where no synchronization is achieved, pattern coincidence determination is repeated until any one of data coincidence patterns shown by “ALL”, “S0”, “S1”, and “S2” in FIG. 6 is detected. Incidentally, in FIG. 6, “X” implies arbitrariness (don't care, i.e., any one of “1” and “0” may be taken).

When a coincidence with any pattern is achieved (when a data coincidence pattern is detected), the wobble (WD) counter section 201 is started, thereby moving the state to the state 1, which is the WDU detection state.

In the state 1, a synchronization detection gate of the synchronization code detection circuit element 206 is opened at a position at which the count value of the wobble counter section 201 has become a multiple of 84 (wobble number corresponding to one WDU), and it is determined whether or not the synchronization code patterns coincide with each other (pattern coincidence determination). That is, by the gate processing of the state 1, erroneous detection of a synchronization code is prevented.

When synchronization code pattern coincidence is normally performed in the gate position, the state where WDU synchronization is achieved is obtained, and the state moves to the next state, i.e., the state 2.

In the state 2, at a position at which the wobble counter has also counted a multiple of 84, it is determined whether or not the sync field patterns coincide with each other (pattern coincidence determination). When a sync field pattern is detected in the stage 2, which means that WAP synchronization is achieved, the state moves to the state 3.

Incidentally, when a coincidence pattern cannot be detected within a specified wobble count number in the state 1 or 2, a transition is provided in which the state is returned to the state 0, and achievement of synchronization is started again from the beginning. This is very valuable as a countermeasure against a case where synchronization is achieved at an incorrect position because of noise, a disk defect or the like.

### Advantage of Example 1

Example 1 is excellent in resistance against a defect of the disk or noise in the transfer system, and can detect wobble sync quickly and correctly.

### EXAMPLE 2

### In which Sync Coincidence Pattern Determination Conditions are Selectively Used in Accordance with the Synchronization State

A synchronization code is, as in Example 1 described above, detected on the basis of the sync pattern coincidence determination shown in FIG. 6.

More specifically, in the state 0 (S0) and the state 1 (S1), strict wobble pattern coincidence determination is performed, thereby reducing generation of synchronization slippage to the utmost.

On the contrary, when the state moves from the state 2 to the next state, the synchronization detection position of the wobble counter section 201 is protected as in Example 1, the coincidence pattern determination conditions are alleviated. For example, even when one wobble of four wobbles (wobble unit) is absent, correction is made in accordance with the polarity of the other three wobbles (in the region indicated by a section D in FIG. 6, in the second to fifth patters of the five patterns, of the four successive wobbles, although the polarity of one wobble is different from the other wobbles, the first pattern in which four wobbles coincide with each other as shown in FIG. 6 is taken). That is, in a low wobble state the quality level of which is not necessarily sufficient, the probability of pattern coincidence is enhanced while management is performed so as not to cause erroneous detection.

Incidentally, in the state 2, for example, a “6T-4T-6T” pattern which is a synchronization pattern of the sync field as shown in FIG. 7 can be detected after a unity field (subsequently to a WDU corresponding to the unity field), a condition for promoting to the state 3, i.e., WAP synchronization completion (OK) is added to the state 2 (on condition that a pattern indicated by “ALL” in FIG. 6 is detected).

Further, apart from the transition described above, when a perfect coincidence pattern constituted of a “6T-4T-6T” pattern (arbitrary pattern shown in FIG. 7) and the wobble polarities in front and behind the above-mentioned pattern is detected in any of all the synchronization states, a transition of moving to the state 3 (completely locked state) by skipping over the intermediate states is provided. This condition has an advantage that the time of the synchronization process (the time required to complete PLL pull-in) is shortened.

### Advantage of Example 2

Example 2 is excellent in resistance against a defect of the disk or noise in the transfer system, and can detect wobble sync quickly and correctly.

### EXAMPLE 3

### In which Correction of the Synchronization Phase is Performed

In the PLL pull-in process (when the state is smaller than the state 2 (S2)), when normal data constituted of five types of patterns shown in FIG. 7 can be detected, the count value of the wobble counter section 201 is corrected to a “value to be originally detected”, thereby correcting the wobble synchronization phase, which is one of the valuable features of the present invention. That is, in the state 0 (S0) or 1 (S1), even when synchronization detection is completed (synchronization is effected) in an incorrect phase (that is, at an incorrect position), it becomes possible to restore the synchronization to the normal position by the processing described below.

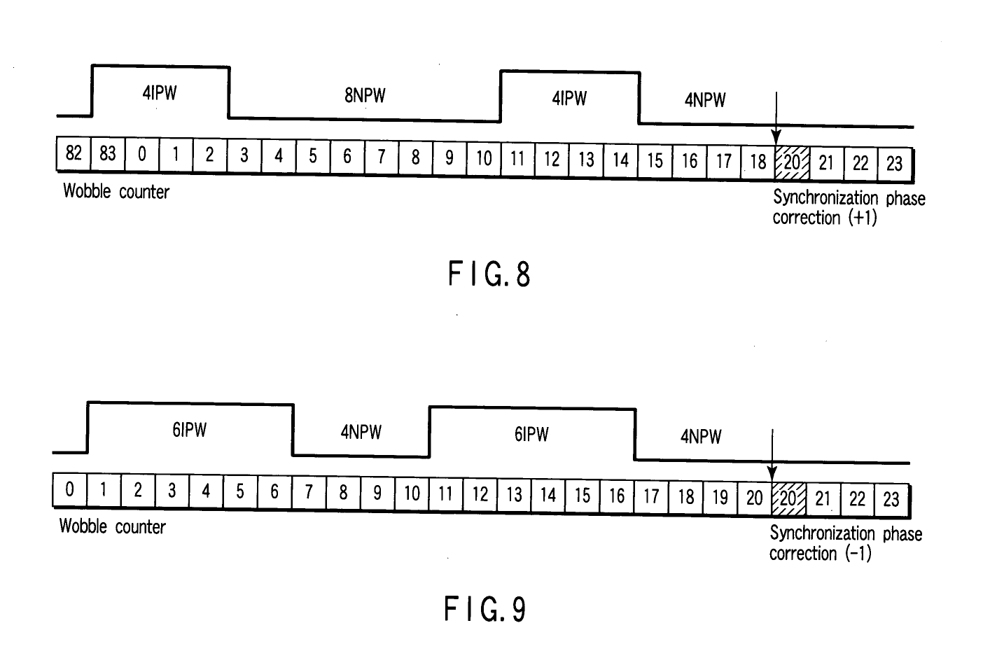

For example, as shown in FIG. 8, when it is detected that the detection position of “4T-8T-4T-4T” is “delayed by one wobble”, the synchronization phase can be corrected by adding “1” to the count value of the wobble counter section 201. Likewise, as shown in FIG. 9, when it is detected that the detection position of “6T-4T-6T-4T” is “one wobble fast”, the synchronization phase can be corrected by subtracting “1” from the count value of the wobble counter section 201.

### Advantage of Example 3

The synchronization positional accuracy and the reliability are improved by detecting wobble synchronization phase slippage which may sometimes occur in the wobble pull-in process, and automatically correcting the synchronization phase to the normal wobble phase.

As has been described above, according to an arbitrary embodiment of the present invention, example 3 is excellent in resistance against a defect of the disk or noise in the transfer system, and can detect wobble sync quickly and correctly.

Further, the synchronization positional accuracy and the reliability are enhanced by detecting wobble synchronization phase slippage which may sometimes occur in the wobble pull-in process, and automatically correcting the synchronization phase to the normal wobble phase.

Accordingly, the time required to reproduce data recorded on the optical disk is shortened, and convenience of the user is improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk apparatus comprising:
an optical head unit including at least a light source, a lens, and an optical detector, for receiving reflection light, and obtaining an output signal corresponding to the light, the reflection light being light from the light source reflected from an information recording region of a recording medium;
a first signal processing section for acquiring first information given a periodical pattern recorded in advance on an information recording region from the output signal from the optical detector, and detecting a specific position of the first information; and
a second signal processing section for acquiring second information recorded at a position subsequent to the specific position of the first information detected by the first signal processing section,
wherein
the first signal processing section identifies a leading head position of the first information on the basis of combinations of positions at which a phase of the periodical pattern is inverted.

2. The optical disk apparatus according to claim 1, wherein
the first signal processing section detects a specific position of the first information on the basis of conditions of combinations of positions at which a phase of the periodical pattern of each of a plurality of patterns prepared in advance is inverted.

3. The optical disk apparatus according to claim 1, wherein
the first signal processing section detects a specific position of the first information by detecting that at least one of the conditions of combinations of positions at which a phase of the periodical pattern of each of a plurality of patterns prepared in advance is inverted has become in coincidence.

4. The optical disk apparatus according to claim 3, wherein
the first signal processing section detects patterns for determination prepared at the leading head or the specific position of the first information as the conditions of combinations of positions at which a phase of the periodical pattern of each of a plurality of patterns prepared in advance is inverted.

5. The optical disk apparatus according to claim 3, wherein
the first signal processing section causes the second signal processing section to immediately start signal processing when the first signal processing section detects that patterns for determination prepared at the leading head or the specific position of the first information have all become in coincidence as the conditions of combinations of positions at which a phase of the periodical pattern of each of a plurality of patterns prepared in advance is inverted.

6. The optical disk apparatus according to claim 1, further comprising:
a third signal processing section for checking, in order to detect that the detected specific position of the first information is incorrect, the specific position of the first information on the basis of contents of the second information when it is detected that at least one of the conditions of combinations of positions at which a phase of the periodical pattern of each of a plurality of patterns prepared in advance is inverted has become in coincidence.

7. The optical disk apparatus according to claim 3, further comprising:
a third signal processing section for checking, in order to detect that the detected specific position of the first information is incorrect, the specific position of the first information on the basis of contents of the second information when it is detected that at least one of the conditions of combinations of positions at which a phase of the periodical pattern of each of a plurality of patterns prepared in advance is inverted has become in coincidence.

8. An optical disk apparatus comprising:
an optical head unit including at least a light source, a lens, and an optical detector, for receiving reflection light, and obtaining an output signal corresponding to the light, the reflection light being light from the light source reflected from an information recording region of a recording medium;
a phase discriminator element for detecting a phase inversion part identified by arrangement of wobble periodical patterns recorded in advance on the information recording region from an output signal of the optical detector;
a first counting element for counting the number of repetitions of the wobble periodical patterns recorded in advance on the information recording region from the output signal of the optical detector;
a second counting element for counting the number of repetitions of the wobble periodical patterns from a counted result of the first counting element in units of a predetermined number;
an address detection element for detecting that a combination of appearance patterns of the phase inversion part coincides with a pattern for determination prepared in advance on the basis of an appearance pattern of the phase inversion part detected by the phase discriminator element;
a status counting element for determining that a position is in the vicinity of a PLL synchronization position, a PLL synchronization position, or a position in which PLL synchronization is enabled, in accordance with degrees of coincidence with the pattern for determination detected by the address detection element; and
a synchronization code detection element for effecting PLL synchronization on the basis of an output from the status counting element and an output from the second counting element.

9. The optical disk apparatus according to claim 8, wherein
the status counting element detects at least one of that a position is in the vicinity of a PLL synchronization position, that the position is a PLL synchronization position, and that the position is a position in which PLL synchronization is enabled, which are determined in accordance with degrees of coincidence between the detected appearance pattern of the phase inversion part and the pattern for determination prepared in advance.

10. The optical disk apparatus according to claim 8, wherein
the status counting element counting element detects that the detected appearance pattern of the phase inversion part coincides with at least one of a leading head determination pattern and a specific position determination pattern of the patterns for determination prepared in advance.

11. The optical disk apparatus according to claim 8, wherein
the status counting element wakes up the synchronization code detection element when the detected appearance pattern of the phase inversion part coincides with both a leading head determination pattern and a specific position determination pattern of the patterns for determination prepared in advance.

12. The optical disk apparatus according to claim 8, wherein
the synchronization code detection element corrects, in order to detect that PLL synchronization is effected at an incorrect position, an output of the first counting element on the basis of a combination of appearance patterns of the phase inversion part detected by the address detection element.

13. The optical disk apparatus according to claim 8, wherein
upon detecting that at least one of the patterns for determination has become in coincidence, the synchronization code detection element corrects, in order to detect that PLL synchronization is effected at an incorrect position, an output of the first counting element on the basis of a combination of appearance patterns of the phase inversion part detected by the address detection element.

14. The optical disk apparatus according to claim 9, wherein
upon detecting that at least one of the patterns for determination has become in coincidence, the synchronization code detection element corrects, in order to detect that PLL synchronization is effected at an incorrect position, an output of the first counting element on the basis of a combination of appearance patterns of the phase inversion part detected by the address detection element.

15. A method for detecting a wobble on the recording layer in an optical disk comprising:
detecting a phase inversion part identified by arrangement of wobble periodical patterns recorded in advance on an information recording region from an output signal corresponding to reflection light reflected from the information recording region of a recording medium;
counting the number of repetitions (wobble number) of the wobble periodical patterns recorded in advance on the information recording region from the output signal corresponding to the reflection light reflected from the information recording region of the recording medium;
counting the number of repetitions of the wobble periodical patterns obtained as a counted result in units of a predetermined number;
obtaining degrees of coincidence between a combination of appearance patterns of the phase inversion part and a pattern for determination prepared in advance on the basis of a detected appearance pattern of the phase inversion part;
determining that a position is in the vicinity of a PLL synchronization position, a PLL synchronization position, or a position in which PLL synchronization is enabled, in accordance with the obtained degrees of coincidence with the pattern for determination; and
effecting PLL synchronization on the basis of the determined degree of coincidence with the pattern for determination and the counted result obtained by counting the wobble periodical patterns in units of a predetermined number.
